(19) United States
(12) Patent Application Publication
(10) Pub. No.: US 2020/0082004 A1
(43) Pub. Date: Mar. 12, 2020

(54) AUTOMATIC DETECTION OF DATABASE CRITICALITY

(71) Applicant: CA, Inc., Islandia, NY (US)

(72) Inventors: Philippe Dubost, Praha (CZ); Jakub Hofman, Praha (CZ); Vikas Sinha, Schaumburg, IL (US)

(21) Appl. No.: 16/123,728

(22) Filed: Sep. 6, 2018

(51) Int. Cl. G06F 17/30; G06N 99/00

(52) U.S. Cl. CPC G06F 17/30377; G06F 17/30309; G06N 99/005; G06F 17/30321; G06F 17/30598

(57) ABSTRACT

In one embodiment, a database object stored in a database is identified, and a transaction history associated with the database object is accessed. A criticality level associated with the database object is determined based on the transaction history, and one or more database maintenance tasks associated with the database object are configured based on the criticality level.

### BACKGROUND

This disclosure relates in general to the field of database management, and more particularly, though not exclusively, to automatic detection of database criticality.

A database administrator (DBA) is typically tasked with configuring, managing, and maintaining a database management system (DBMS) in order to facilitate efficient access to the underlying data. For example, a database administrator may regularly perform, schedule, or configure various database maintenance or “housekeeping” tasks, such as data backup and recovery, performance optimizations, and so forth. In order to perform the appropriate database maintenance tasks, however, a database administrator needs to understand which database objects are used by which applications, as well as the criticality or importance of the respective applications and their associated database objects, among other information. A database administrator typically has to derive this information manually, which can often be a tedious and error-prone task, particularly as the scale and complexity of a system increases.

### BRIEF SUMMARY

According to one aspect of the present disclosure, a database object stored in a database is identified, and a transaction history associated with the database object is accessed. A criticality level associated with the database object is determined based on the transaction history, and one or more database maintenance tasks associated with the database object are configured based on the criticality level.

### BRIEF DESCRIPTION OF THE DRAWINGS

FIG. 1 illustrates an example embodiment of a computing system with automatic database criticality detection in accordance with certain embodiments.

FIG. 2 illustrates an example embodiment of a database criticality detection system.

FIG. 3 illustrates a process flow for an example embodiment of automatic database criticality detection.

FIG. 4 illustrates an example of a business application group.

FIG. 5 illustrates an example of business application groups with varying levels of criticality.

FIG. 6 illustrates an example of assigning criticality levels to business applications groups based on the statistical distribution of their business criticality indexes (BCIs).

FIG. 7 illustrates an example of assigning criticality levels to business application groups using a machine learning clustering algorithm.

FIG. 8 illustrates an example of using machine learning to predict the criticality of newly deployed applications and/or objects.

FIG. 9 illustrates a flowchart for an example embodiment of automatic database criticality detection.

### DETAILED DESCRIPTION OF EXAMPLE EMBODIMENTS

As will be appreciated by one skilled in the art, aspects of the present disclosure may be illustrated and described herein in any of a number of patentable classes or contexts, including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or as a combination of software and hardware implementations, all of which may generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider), or in a cloud computing environment, or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices, to produce a computer implemented process such that the instructions which execute on the computer or other programmable apparatus provide processes for implementing the functions/acts specified in the flowchart and/or block diagram block or blocks.

Example embodiments that may be used to implement the features and functionality of this disclosure will now be described with more particular reference to the attached FIGURES.

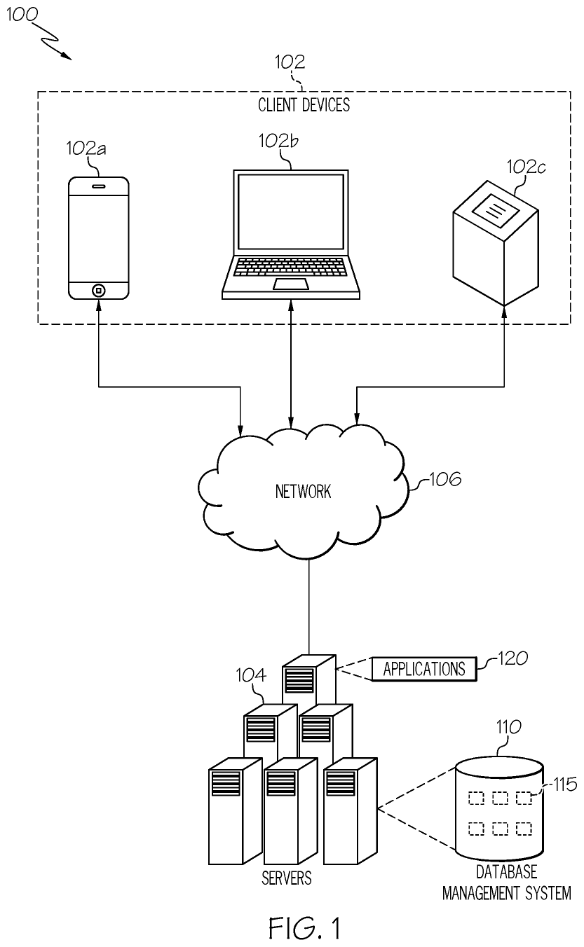

FIG. 1 illustrates an example embodiment of a computing system 100 that provides automatic database criticality detection in accordance with certain embodiments. In the illustrated embodiment, for example, system 100 includes a database management system (DBMS) 110 that automatically detects the criticality of objects 115 in a database in order to facilitate database administration, as described further below.

Large enterprises typically run a variety of business applications 120 that are designed to provide certain services and/or interact with users, such as customers, employees, and so forth. In the illustrated embodiment, business applications 120 are hosted or deployed on one or more datacenter servers 104 and are designed to communicate and/or interact with other components of system 100 via network 106. In some embodiments, for example, business applications 120 may interact with users via client devices 102a-c, such as mobile devices, laptops, desktops, kiosks, ATMs, and so forth. Moreover, business applications 120 may rely on a database management system (DBMS) 110 to manage large volumes of data that are required by the applications. Examples of commercially available database management systems include IBM DB2, Oracle, MySQL, and Microsoft SQL Server, among others. In some embodiments, DBMS 110 may manage access to data using a query language, such as the Structured Query Language (SQL). Further, DBMS 110 may store and/or organize the data using various types of database objects 115, such as indexes, tables, views, and so forth.

A database administrator (DBA) is typically tasked with configuring, managing, and maintaining a database management system (DBMS) in order to facilitate efficient access to the underlying data. For example, a database administrator may regularly perform, schedule, or configure various database maintenance or “housekeeping” tasks, such as data backup and recovery, performance optimizations, and so forth. Typically, a database administrator must perform manual inspections in order to determine how to best define the maintenance tasks for each database object managed by the database management system. For example, in order to perform the appropriate database maintenance tasks, a database administrator needs to understand which database objects are used by which business applications, the relationships between the respective business applications, and the criticality or importance of the respective business applications and their associated database objects. Traditionally, a database administrator would have to derive this information manually due to the lack of suitable programmatic approaches. However, techniques for automatically identifying groups of related business applications and their associated database objects have been presented in U.S. patent application Ser. Nos. 14/669,081 and 14/673,957, respectively filed on Mar. 26, 2015 and Mar. 31, 2015, entitled “Grouping of Database Objects,” the contents of which are hereby expressly incorporated by reference.

In order to properly perform the appropriate database maintenance and housekeeping tasks, however, a database administrator also needs to understand the business criticality of the various business applications and their associated database objects. Business criticality, for example, may refer to the impact on a business that results from poor performance, downtime, and/or unavailability of a particular business application and/or an associated database object. The business criticality is typically higher for applications and/or database objects that have a larger impact on the business, and lower for those that have a smaller impact on the business. A database administrator typically has to determine the business criticality of each application and/or database object manually, as there were previously no suitable programmatic approaches available for that purpose. This task might be somewhat easier if the respective lines of business (LOBs) were each able to specify the business impact of their associated business applications at a granular level, but that is often difficult, impractical, or impossible, particularly for large enterprises with many LOBs and associated business applications.

Accordingly, in the illustrated embodiment, database management system (DBMS) 110 automatically detects the criticality of business applications 120 and/or associated database objects 115 in computing system 100 in order to facilitate database administration. In some embodiments, for example, the criticality of the database objects 115 associated with a particular business application 120 may be determined by analyzing the transaction history of the respective database objects 115. For example, a database management system typically maintains a transaction log that reflects past transactions associated with each database object, such as transactions performed pursuant to SQL queries, statements, or commands issued by applications, users, administrators, and so forth. The transaction log typically includes a variety of information associated with each transaction, such as the particular SQL command or transaction that was executed (e.g., SELECT, UPDATE, INSERT, CREATE, DELETE), the relevant database object(s) implicated by the command (e.g., database tables, indexes, procedures), any parameters specified by the command (e.g., data to be stored or retrieved), an identifier of the application and/or user that generated the command, a timestamp with the time and date of the command, and so forth. Moreover, various metrics associated with each database object may also be computed and/or tracked based on the past transactions, such as an SQL hit ratio, copy or backup frequency, reorganization frequency, and so forth. In this manner, the criticality of the database objects 115 associated with a particular business application 120 may be determined by analyzing the transaction history and/or metrics of the corresponding database objects 115, such as the SQL hit ratio, copy frequency, and/or reorganization frequency, among other examples.

In some embodiments, for example, a business criticality index (BCI) may be computed for each business application 120 based on the metrics tracked for its associated database objects 115, and a criticality level may then be assigned to each application 120 based on its computed BCI. The BCI for each business application 120 can be computed using any appropriate methodology or formula, such as a weighted average of the relevant metrics tracked for its associated database object(s) 115 (e.g., hit ratio, copy frequency, reorganization frequency), among numerous other possibilities. In some cases, for example, a BCI may be computed as a numerical value within a certain range or interval, such as a value in the range [0, 1] or [0, 100], such that the magnitude of the BCI is indicative of the level of criticality of the business application 120.

A criticality level may then be assigned to each application 120 based on its computed BCI, such as a criticality level of LOW, MEDIUM, HIGH, or CRITICAL. In some embodiments, for example, the criticality levels could be defined statically based on predetermined BCI ranges, such as the following:

LOW: [0, 25];

MEDIUM: [25, 50];

HIGH: [50, 75]; and

CRITICAL: [75, 100].

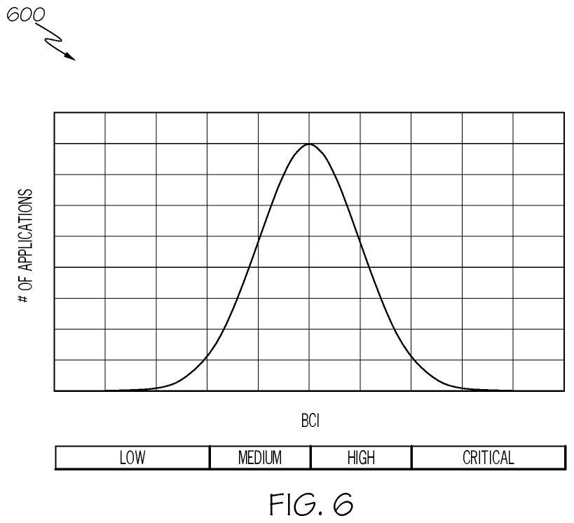

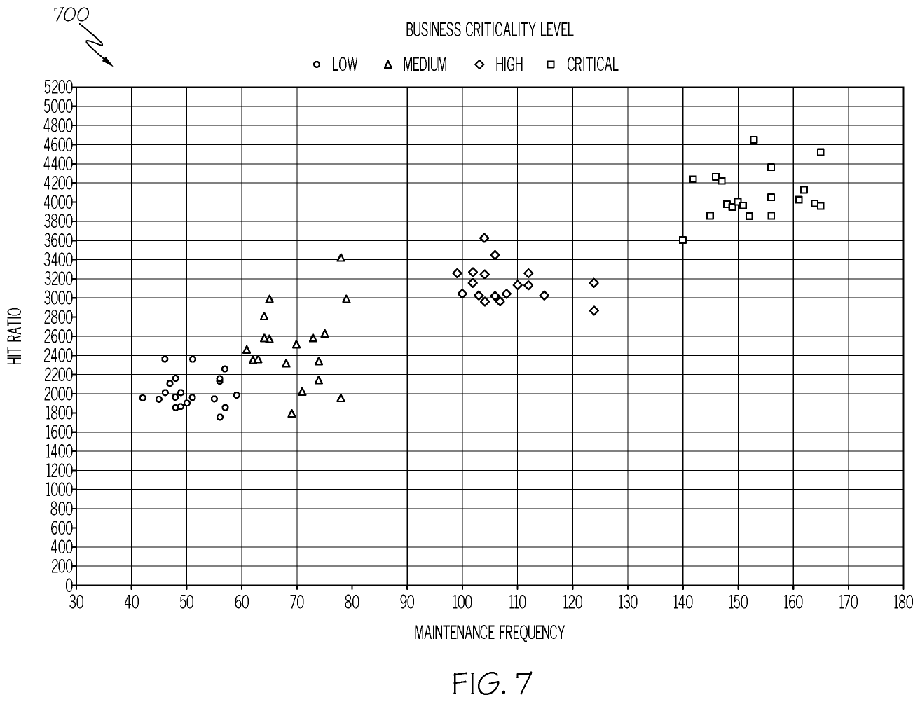

Alternatively, the criticality levels could be determined dynamically, such as based on the statistical distribution of BCIs and/or using machine learning techniques. For example, the criticality levels could be defined using varying BCI ranges derived from the statistical distribution of BCIs for all business applications 120 and/or database objects 115 (e.g., as illustrated in FIG. 6). As another example, the criticality levels could be dynamically determined using machine learning techniques. For example, the transaction metrics associated with the database objects 115 (and/or the BCIs or statistical distribution of BCIs computed from those metrics) could be supplied as input to a machine learning clustering algorithm, which then partitions the database objects 115 and/or the associated business applications 120 into different clusters or tiers that each correspond to a particular criticality level (e.g., as illustrated in FIG. 7).

Further, in some embodiments, the criticality levels could be determined using a combination of the approaches described above. Moreover, in varying embodiments, the criticality levels and/or BCIs may either be determined for each individual database object 115, or for each business application 120 based on an associated group of database objects 115. It should also be appreciated that the approaches described above are merely examples of how the criticality of business applications 120 can be derived from the transaction metrics of database objects 115. Accordingly, in other embodiments, any suitable approach may be used to compute BCIs and/or determine criticality levels based on the transaction metrics of database objects 115.

Once the criticality of the respective business applications 120 and/or database objects 115 has been determined, the appropriate database maintenance tasks for the database objects 115 can then be set up, configured, and/or scheduled. For example, when the BCI and/or criticality level of each business application 120 is known, the database administrator has a clear and simplified view of each database object 115 and can verify that the current maintenance tasks are properly configured. For example, based on the criticality level of each application 120 and possibly any service level agreements (SLAs) that may be in place, various database maintenance or “housekeeping” tasks may be configured and/or scheduled for each database object 115, such as data backup and recovery, performance optimizations, and so forth. For example, based on the respective criticality levels, the maintenance tasks may be configured for the database objects 115 in a manner that satisfies any service level agreements (SLAs) that have been defined by the business.

An example database maintenance configuration is illustrated below in TABLE 1. In the illustrated example, maintenance tasks for reorganizing and copying (e.g., backing up) database objects are defined on a per-criticality level basis. For example, reorganization is defined based on a threshold level of organization that must be maintained for the database objects in each criticality level, while copying is defined based on a specified copy frequency for the database objects in each criticality level. In this manner, maintenance tasks are triggered for database objects based on the configuration parameters for their respective criticality levels. For example, based on the configuration in TABLE 1, a database object with a criticality level of “HIGH” may be reorganized whenever necessary to maintain a 95% level of organization, and may further be copied or backed up once per day.

TABLE 1
Database maintenance configuration based on criticality

| | | COPY |
|---|---|---|
| CRITICALITY LEVEL | REORG THRESHOLD | FREQUENCY |
| CRITICAL | >99% | Hourly |
| HIGH | >95% | Daily |
| MEDIUM | >90% | Weekly |
| LOW | >80% | Monthly |

Further, throughout the ordinary course of business, it is common for a business to create new database objects 115 and/or deploy new business applications 120. When a new database object 115 and/or business application 120 is initially created and/or deployed, however, the transaction metrics required to reliably determine a criticality level using the approach described above may not be immediately available, as those metrics may not exist yet or may otherwise be incomplete. Accordingly, before relying on the approach described above, it may be desirable to wait until the transaction metrics have matured, such as after the metrics have been collected for some minimum or threshold amount of time.

In some embodiments, however, machine learning may be leveraged in order to predict the criticality of a new database object 115 and/or business application 120 before its transaction metrics have matured. For example, the transaction metrics and corresponding criticality data computed for existing database objects 115 and/or business applications 120 may be used to train a machine learning model to predict the criticality of new database objects 115 and/or business applications 120. In this manner, the criticality of a new database object 115 and/or business application 120 can initially be predicted using machine learning based on the limited transaction metrics that are immediately available, and the predicted criticality can subsequently be updated once the transaction metrics have matured such that a reliable criticality level can be determined.

Additional details and embodiments associated with automatic database criticality detection are described throughout this disclosure in connection with the remaining FIGURES.

In general, elements of computing system 100, such as “systems,” “servers,” “services,” “devices,” “clients,” “networks,” “computers,” and any components thereof, may be used interchangeably herein and refer to computing devices operable to receive, transmit, process, store, or manage data and information associated with computing system 100. Moreover, as used in this disclosure, the term “computer,” “processor,” “processor device,” or “processing device” is intended to encompass any suitable processing device. For example, elements shown as single devices within computing system 100 may be implemented using a plurality of computing devices and processors, such as server pools comprising multiple server computers. Further, any, all, or some of the computing devices may be adapted to execute any operating system, including Linux, other UNIX variants, Microsoft Windows, Windows Server, Mac OS, Apple iOS, Google Android, etc., as well as virtual machines adapted to virtualize execution of a particular operating system, including customized and/or proprietary operating systems.

Moreover, elements of computing system 100 (e.g., client devices 102a-c, servers 104, network 106, database management system 110, and so forth) may each include one or more processors, computer-readable memory, and one or more interfaces, among other features and hardware. Servers may include any suitable software component or module, or computing device(s) capable of hosting and/or serving software applications and services, including distributed, enterprise, or cloud-based software applications, data, and services. For instance, one or more of the described components of computing system 100, may be at least partially (or wholly) cloud-implemented, “fog”-implemented, web-based, or distributed for remotely hosting, serving, or otherwise managing data, software services, and applications that interface, coordinate with, depend on, or are used by other components of computing system 100. In some instances, elements of computing system 100 may be implemented as some combination of components hosted on a common computing system, server, server pool, or cloud computing system, and that share computing resources, including shared memory, processors, and interfaces.

Further, the network(s) 106 used to communicatively couple the components of computing system 100 may be implemented using any suitable computer communication or network technology for facilitating communication between the participating components. For example, one or a combination of local area networks, wide area networks, public networks, the Internet, cellular networks, Wi-Fi networks, short-range networks (e.g., Bluetooth or ZigBee), and/or any other wired or wireless communication medium may be utilized for communication between the participating devices, among other examples.

While FIG. 1 is described as containing or being associated with a plurality of elements, not all elements illustrated within computing system 100 of FIG. 1 may be utilized in each alternative implementation of the embodiments of this disclosure. Additionally, one or more of the elements described in connection with the examples of FIG. 1 may be located external to computing system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Additional embodiments and functionality associated with the implementation of computing system 100 are described further in connection with the remaining FIGURES. Accordingly, it should be appreciated that computing system 100 of FIG. 1 may be implemented with any aspects or functionality of the embodiments described throughout this disclosure.

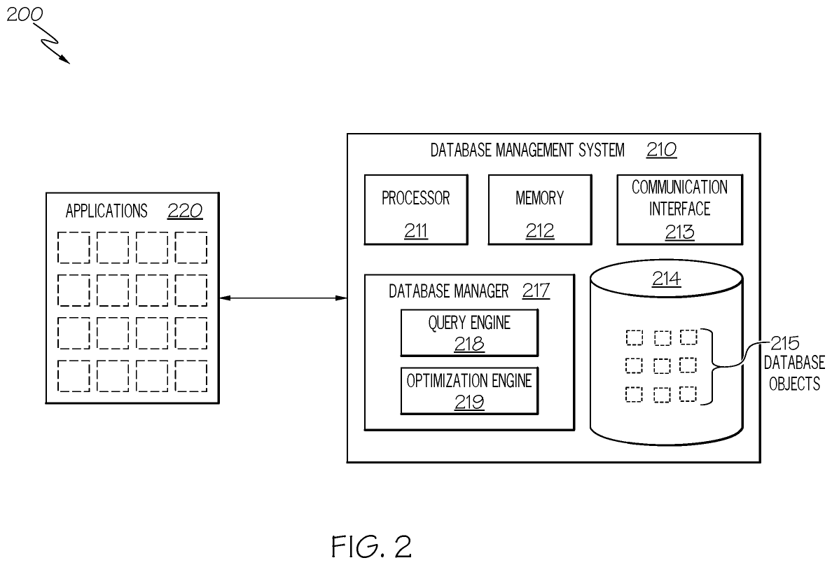

FIG. 2 illustrates an example embodiment of a database criticality detection system 200. In some embodiments, for example, database criticality detection system 200 may be used to implement the automatic database criticality detection functionality described throughout this disclosure.

In the illustrated embodiment, database criticality detection system 200 includes a database management system 210 in communication with a plurality of business applications 220. Business applications 220, for example, may include any type of software or computing component, such as a software application, program, microservice, microservice application, library, module, and/or any portion or component of a larger, multi-tiered software system, among other examples. Moreover, business applications 220 may rely on database management system (DBMS) 210 to manage large volumes of data that are required by the applications.

Database management system 210 includes a processor 211, memory element 212, communication interface 213, data storage 214, and database manager 217. Processor 211 may be used to execute logic and/or instructions stored in memory 212, such as the logic and/or instructions used to implement database manager 217. Communication interface 213 may be used to communicate with external systems and components, such as business applications 220, as well as other database management systems 210 in distributed embodiments. Data storage 214 is used to implement a database for storing large volumes of data within a variety of database objects 215. Database manager 217 is used to manage the data stored on data storage 214. For example, database manager 217 may organize the data into a variety of database objects 215, such as indexes, tables, views, and so forth. Moreover, database manager 217 includes a query engine 218 to manage access to the data stored in the database objects 215 (e.g., using a query language such as SQL). Database manager 217 also includes an optimization engine 219 to optimize the performance of database management system 210. In some embodiments, for example, optimization engine 219 may be used to implement the automatic database criticality detection functionality described throughout this disclosure.

In some implementations, the various illustrated components of database criticality detection system 200, and/or any other associated components, may be combined, or even further divided and distributed among multiple different systems. For example, in some implementations, database management system 210 may be implemented as a single component, device, or system, or alternatively may be distributed across multiple distinct components, devices, or systems that respectively include varying combinations of its underlying components (e.g., 211-219). As another example, in various embodiments, optimization engine 219 may be implemented as an integrated component within database manager 217 or alternatively as a separate application that operates in conjunction with database manager 217.

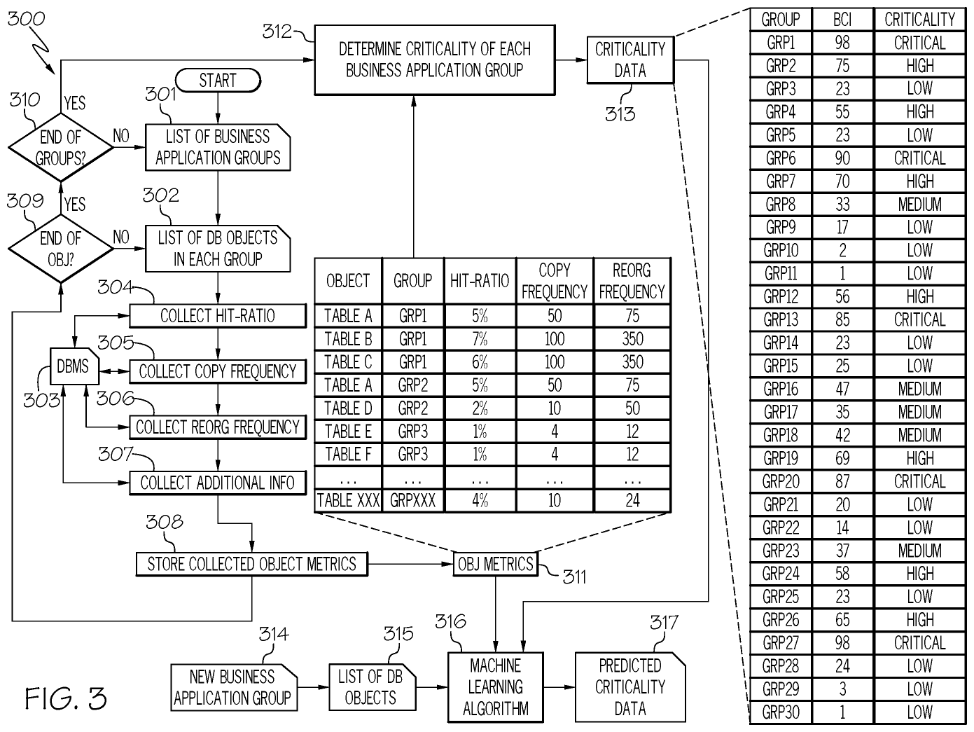

FIG. 3 illustrates a process flow 300 for an example embodiment of automatic database criticality detection. In some embodiments, process flow 300 may be implemented using the components and functionality described throughout this disclosure (e.g., computing system 100 of FIG. 1 and/or database criticality detection system 200 of FIG. 2).

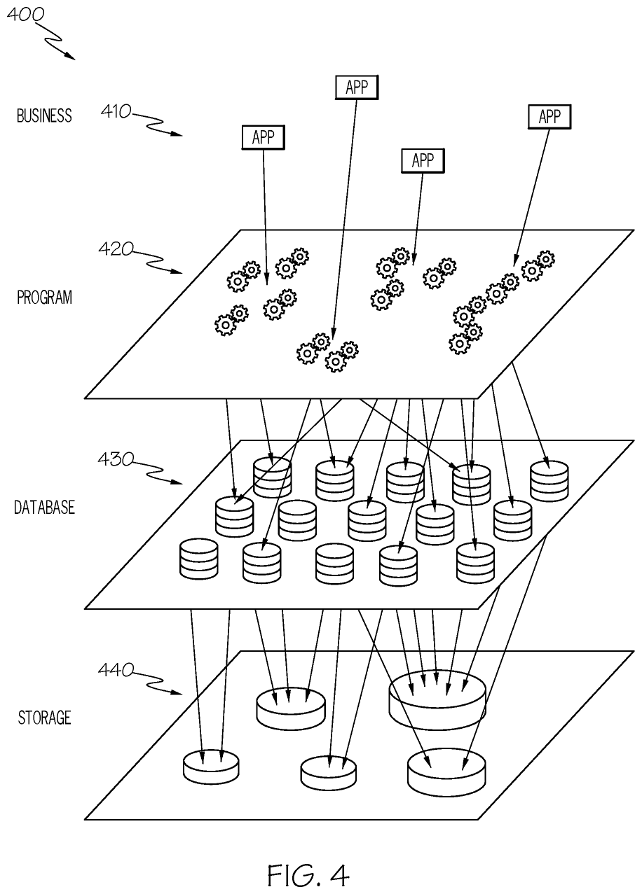

The process flow begins by obtaining a list 301 of business application groups deployed by a particular business, along with a list 302 of database objects that are used by each business application group. The concept of a business application group is illustrated by FIG. 4, which depicts an example 400 of the hierarchical relationship between business application groups 410, programs 420, database objects 430, and physical storage 440. A business application group 410, for example, may refer to one or more business applications that have a close relationship, such as a group of business applications that collectively provide a particular service or otherwise serve a similar business purpose. A business application group 410 is typically a subset of a larger collection of applications or programs 420 that are deployed by a particular business or enterprise. Moreover, some or all of those applications or programs 420 may depend on data that is maintained in a database using a collection of database objects 430 (e.g., tables, indexes), which may be physically stored on one or more physical storage devices 440. In the illustrated example, the database objects 430 are distributed across a collection of physical storage devices 440.

Turning back to FIG. 3, the list 301 of business application groups and the list 302 of corresponding database objects may either be created manually (e.g., by a database administrator) or generated automatically (e.g., using the techniques presented in U.S. patent application Ser. Nos. 14/669,081 and 14/673,957).

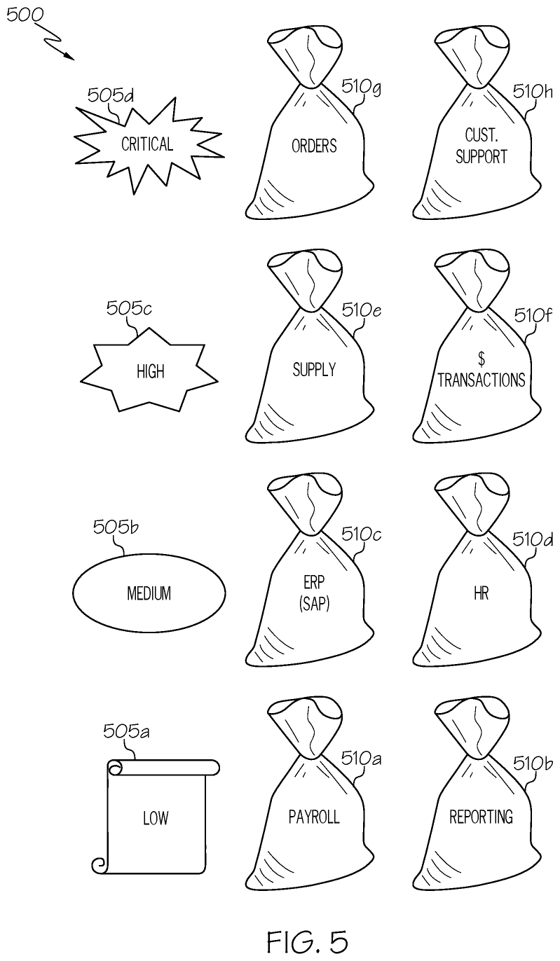

In order to perform the appropriate database maintenance and housekeeping tasks, however, a database administrator also needs to understand the business criticality or importance of the various business application groups and their associated database objects. An example of typical business application groups with varying levels of criticality is illustrated in FIG. 5. In the example 500 of FIG. 5, business application groups 510a-h are designated with criticality levels 505a-d. For example, payroll 510a and reporting 510b are designated with a criticality level of LOW 505a, enterprise resource planning (ERP) 510c and human resources (HR) 510d are designated with a criticality level of MEDIUM 505b, supply 510e and transactions 510f are designated with a criticality level of HIGH 505c, and orders 510g and customer support 510h are designated with a criticality level of CRITICAL 505d.

The task of determining the criticality of each business application group for database maintenance purposes has traditionally been performed manually by a database administrator. Turning back to FIG. 3, however, that task is now performed programmatically. For example, in FIG. 3, the criticality of each business application group is determined by analyzing transaction information and/or metrics associated with the underlying database object(s), such as SQL hit ratio, copy frequency, reorganization frequency, and so forth.

Accordingly, after the lists of business application groups and associated database objects 301, 302 have been obtained, the process flow then proceeds to blocks 304-307, where various types of transaction data and/or metrics are collected from the database management system (DBMS) 303 for each database object of each business application group. For example, beginning with the first database object of the first business application group, the following types of transaction data may be collected: SQL hit ratio (block 304), copy frequency (block 305), reorganization frequency (block 306), and/or any other transaction metrics or information (block 307).

The SQL hit ratio, for example, may indicate a number or percentage of all queries that resulted in a hit on the particular database object (e.g., a ratio of the number of SQLs statements that hit the particular database object over the total number of SQLs statements in the DBMS workload). In this manner, based on the assumption that critical business application groups tend to be used more heavily, their underlying database objects will get hit more frequently, and thus their hit ratio will be higher.

The copy frequency may indicate the number of image copies (e.g., backups) taken of the particular database object per a certain time interval. In this manner, based on the assumption that critical business application groups likely have more stringent SLA requirements for backup and recovery, their underlying database objects are likely to be copied more frequently than others.

The reorganization frequency may indicate the number of reorganizations performed on the particular database object per a certain time interval. In this manner, based on the assumption that critical business application groups require very high performance, their underlying database objects are likely to be reorganized more frequently than others (e.g., for performance purposes).

In some cases, for example, the copy frequency and reorganization frequency may be based on a time interval of one year. If metrics for the particular database object are not available for the full time interval, however, in some cases they may extrapolated for the full time interval based on the length of history available. Moreover, in some embodiments, the transaction data may be collected from a transaction log maintained by the database management system (DBMS). For example, with respect to an IBM DB2 database management system, the copy frequency and/or reorganization frequency may be derived or extracted from data in the SYSCOPY table. Moreover, in various embodiments, other types of transaction metrics may also be used, depending on what type of data is available in the particular database management system (DBMS).

The process flow then proceeds to block 308, where the transaction data collected for the particular database object is stored in a table of aggregated object metrics 311.

The process flow then proceeds to block 309 to determine whether all database objects of the current business application group have been processed, and similarly to block 310 to determine whether all business application groups have been processed. In this manner, the process flow continues cycling through blocks 304-308 until metrics for every database object of every business application group have been collected and stored in the object metrics table 311. An example of the resulting object metrics table 311 is illustrated in FIG. 3 and is also shown below in TABLE 2.

TABLE 2
Object metrics

| | | | COPY | REORG |
|---|---|---|---|---|
| OBJECT | GROUP | HIT-RATIO | FREQUENCY | FREQUENCY |
| Table A | GRP 1 | 5% | 50 | 75 |
| Table B | GRP 1 | 7% | 100 | 350 |
| Table C | GRP 1 | 6% | 100 | 350 |
| Table A | GRP 2 | 5% | 50 | 75 |
| Table D | GRP 2 | 2% | 10 | 50 |
| Table E | GRP 3 | 1% | 4 | 12 |
| Table F | GRP 3 | 1% | 4 | 12 |
| . . . | . . . | . . . | . . . | . . . |
| Table xxx | GRP xxx | 4% | 10 | 24 |

The process flow then proceeds to block 312 to determine the criticality 313 of each business application group based on the object metrics 311. In some embodiments, for example, a business criticality index (BCI) may be computed for each business application group based on the transaction metrics, and a criticality level may then be assigned to each business application group based on its computed BCI. The BCI for each business application group can be computed using any appropriate methodology or formula, such as a weighted average of the relevant metrics tracked for its associated database object(s) (e.g., hit ratio, copy frequency, reorganization frequency), and/or using a machine learning model, among other examples.

In some cases, for example, a BCI may be computed as a numerical value within a certain range or interval, such as a value in the range [0, 1] or [0, 100], such that the magnitude of the BCI is indicative of the level of criticality of the business application group. A criticality level may then be assigned to each business application group based on its computed BCI, such as a criticality level of LOW, MEDIUM, HIGH, or CRITICAL.

In some embodiments, for example, the criticality levels could be defined statically based on predetermined BCI ranges, such as the following:

LOW: [0, 25];

MEDIUM: [25, 50];

HIGH: [50, 75]; and

CRITICAL: [75, 100].

Alternatively, the criticality levels could be determined dynamically, such as based on the statistical distribution of BCIs (e.g., statistical clustering) and/or using machine learning techniques. For example, the criticality levels could be defined using varying BCI ranges derived from the statistical distribution of BCIs for all business application groups, as shown in FIG. 6. In particular, FIG. 6 illustrates an example 600 of the criticality levels assigned to various BCI ranges based on a hypothetical Gaussian distribution of BCIs for the respective business application groups.

As another example, the criticality levels could be dynamically determined using machine learning rather than a more “straightforward” calculation. For example, the object metrics 311 (and/or the BCIs or statistical distribution of BCIs computed from those metrics) could be supplied as input to a machine learning clustering algorithm (e.g., k-means clustering, mean-shift clustering), which partitions the business application groups into different clusters or tiers that each correspond to a particular criticality level. For example, based on the database object metrics 311 associated with the respective business application groups (e.g., hit ratio, copy frequency, reorganization frequency), a machine learning clustering algorithm may derive clusters of business applications and/or database objects that correspond to varying levels of business criticality. This approach is illustrated in FIG. 7, which shows a chart 700 depicting the criticality levels determined for a sample dataset using a machine learning clustering algorithm. For ease of illustration, a two-dimensional (2D) chart is shown, where the x-axis represents the maintenance frequency (which includes both copy frequency and reorganization frequency) and the y-axis represents the hit ratio. As shown in the illustrated example, four distinct clusters of business applications and/or database objects appear in the chart, which respectively correspond to criticality levels of LOW, MEDIUM, HIGH, and CRITICAL.

Further, in some embodiments, the criticality levels could be determined using a combination of the approaches described above (e.g., calculating probabilities and utilization of the percentiles and/or a density function(s)). Moreover, in varying embodiments, the criticality levels and/or BCIs may be computed at any desired level of granularity, such as for each business application group, each individual business application, and/or each individual database object. It should also be appreciated that the approaches described above are merely examples of how the criticality of business applications can be derived from database object metrics. Accordingly, in other embodiments, any suitable approach may be used to compute BCIs and/or determine criticality levels based on transaction metrics of database objects.

Turning back to FIG. 3, an example of the computed criticality data for business application groups 1-3 from object metrics table 311 is shown below in TABLE 3.

TABLE 3
Example criticality data

| GROUP | BCI | CRITICALITY |
|---|---|---|
| GRP 1 | 98 | CRITICAL |
| GRP 2 | 74 | HIGH |
| GRP 3 | 23 | LOW |

In the real world, however, there will typically be numerous database objects and related business application groups, so a more realistic example of the resulting criticality data 313 is illustrated in FIG. 3 and also shown below in TABLE 4.

TABLE 4
Example criticality data

| GROUP | BCI | CRITICALITY |
|---|---|---|
| GRP 1 | 98 | CRITICAL |
| GRP 2 | 75 | HIGH |
| GRP 3 | 23 | LOW |
| GRP 4 | 55 | HIGH |
| GRP 5 | 23 | LOW |
| GRP 6 | 90 | CRITICAL |
| GRP 7 | 70 | HIGH |
| GRP 8 | 33 | MEDIUM |
| GRP 9 | 17 | LOW |
| GRP 10 | 2 | LOW |
| GRP 11 | 1 | LOW |
| GRP 12 | 56 | HIGH |
| GRP 13 | 85 | CRITICAL |
| GRP 14 | 23 | LOW |
| GRP 15 | 25 | LOW |
| GRP 16 | 47 | MEDIUM |
| GRP 17 | 35 | MEDIUM |
| GRP 18 | 42 | MEDIUM |
| GRP 19 | 69 | HIGH |
| GRP 20 | 87 | CRITICAL |
| GRP 21 | 20 | LOW |
| GRP 22 | 14 | LOW |
| GRP 23 | 37 | MEDIUM |
| GRP 24 | 58 | HIGH |
| GRP 25 | 23 | LOW |
| GRP 26 | 65 | HIGH |
| GRP 27 | 98 | CRITICAL |
| GRP 28 | 24 | LOW |
| GRP 29 | 3 | LOW |
| GRP 30 | 1 | LOW |

Once the criticality of the respective business application groups has been determined, the appropriate database maintenance tasks for the underlying database objects can then be set up, configured, and/or scheduled, as described further throughout this disclosure. Further, this process can be performed periodically using the latest object metrics to ensure that the criticality data for all business application groups is up to date (e.g., in the event the criticality level changes for any of the business application groups).

Further, throughout the ordinary course of business, it is common for new business application groups, business applications, and/or database objects to be deployed over time. When a new business application and/or database object 314 is initially deployed, however, the database object metrics required to reliably determine a criticality level using the approach described above may not be immediately available, as those metrics may not yet exist or may otherwise be incomplete. Accordingly, in some embodiments, machine learning (e.g., k-means clustering, mean-shift clustering) may be leveraged in order to predict the criticality of a newly launched business application group 314 (e.g., before its database object metrics have matured). For example, the object metrics 311 and corresponding criticality data 313 associated with the existing business application groups may serve as input to a machine learning algorithm 316 that trains a model to predict the criticality of new business application groups. In this manner, criticality data 317 (e.g., BCI and/or criticality level) for a new business application group 314 can initially be predicted by the trained machine learning model 316 based on the limited object metrics that are immediately available for its associated database objects 315.

Moreover, in some embodiments, the predicted criticality 317 can subsequently be updated once the object 315 metrics for the new business application group 314 have matured to the point that a reliable criticality level can be computed at block 312 (e.g., after the metrics have been collected for some minimum or threshold amount of time).

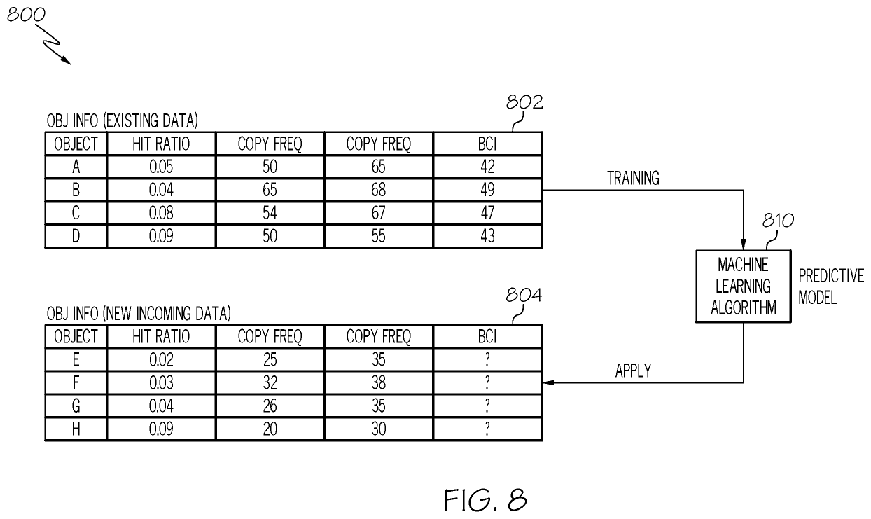

FIG. 8 illustrates an example 800 of using machine learning to predict the criticality of newly deployed objects, such as new business applications groups, new business applications, and/or new database objects. In the illustrated example, a machine learning scoring algorithm 810 is used to predict business criticality of new objects based on their similarities with existing objects. For example, the machine learning scoring algorithm 810 is first trained using data associated with the existing objects 802, such as their corresponding object metrics (e.g., hit ratio, copy frequency, reorganization frequency) and criticality data (e.g., BCI and/or criticality level). Accordingly, when new object(s) are launched or deployed, their criticality (e.g., BCI and/or criticality level) can be predicted by applying the trained machine learning scoring algorithm 810 to the limited metrics 804 that are available for the new object(s). In some cases, for example, the limited metrics 804 for the new object(s) may still include a hit ratio, copy frequency, and reorganization frequency, but those metrics may be based on a very limited period of time. In other cases, some of those types of metrics may initially be altogether unavailable.

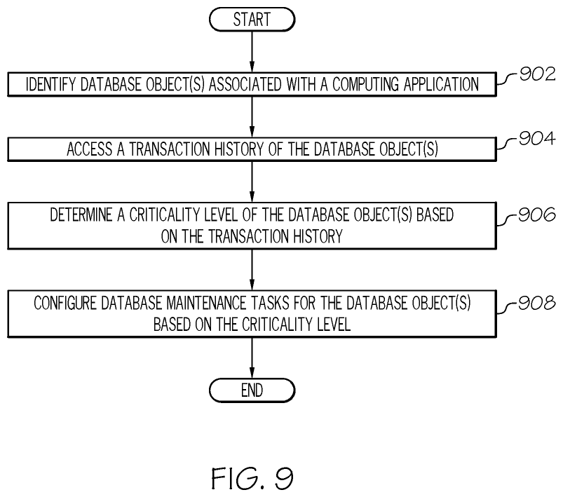

FIG. 9 illustrates a flowchart 900 for an example embodiment of automatic database criticality detection. In some embodiments, flowchart 900 may be implemented using the embodiments and functionality described throughout this disclosure (e.g., computing system 100 of FIG. 1 and/or database criticality detection system 200 of FIG. 2).

The flowchart may begin at block 902 by identifying one or more database object(s), such as a database table or index, that is associated with a computing application (or a group of computing applications) that is executable by one or more processors.

The flowchart may then proceed to block 904 to access a transaction history associated with the database object. For example, the transaction history may include transaction metrics associated with the database object (or alternatively may include data that can be used to derive transaction metrics), such as a hit ratio, copy frequency, reorganization frequency, and so forth.

The flowchart may then proceed to block 906 to determine a criticality level of the database object based on the transaction history.

In some embodiments, for example, a criticality index associated with a database object may be computed based on the transaction history, and then a criticality level may be determined based on the criticality index. The criticality level, for example, may be determined by: identifying a plurality of ranges corresponding to a plurality of criticality levels (e.g., low, medium, high, and critical), identifying the particular range that the criticality index falls within, and then identifying the criticality level corresponding to the identified range. Moreover, in some embodiments, the ranges corresponding to the respective criticality levels may be identified by identifying or computing criticality indexes associated with a plurality of database objects, identifying a statistical distribution of the criticality indexes, and determining the ranges based on the statistical distribution.

Alternatively, in some embodiments, the criticality level of the database object may be determined by: accessing a plurality of transaction histories associated with a plurality of database objects, partitioning the plurality of database objects into a plurality of clusters based on the plurality of transaction histories, assigning a plurality of criticality levels to the plurality of clusters, identifying the particular cluster that contains the database object of interest, and identifying the criticality level corresponding to that cluster. In some embodiments, for example, the database objects may be partitioned into clusters by applying a machine learning clustering model based on the transaction histories, and then identifying the clusters based on an output of the machine learning clustering model.

The flowchart may then proceed to block 908 to configure one or more database maintenance tasks for the database object(s) based on the determined criticality level, as described further throughout this disclosure.

Moreover, in some embodiments, the flowchart may also include functionality (not shown) for predicting the criticality of a new database object that is added to a database. For example, upon determining that a new database object has been added to the database, a partial transaction history associated with the new database object may be accessed, along with transaction histories and criticality data associated with existing database objects within the database. A predicted criticality level may then be determined for the new database object based on its partial transaction history along with the transaction histories and criticality data for the existing database objects. In some embodiments, for example, the predicted criticality level may be determined by: training a machine learning classification model based on the transaction histories and criticality data associated with the existing database objects; applying the machine learning classification model to the partial transaction history associated with the new database object; and determining the predicted criticality level of the new database object based on an output of the machine learning classification model. In this manner, one or more database maintenance tasks may then be configured for the new database object based on its predicted criticality level.

At this point, the flowchart may be complete. In some embodiments, however, the flowchart may restart and/or certain blocks may be repeated. For example, in some embodiments, the flowchart may restart at block 902 to continue determining the criticality level of database objects and/or computing applications.

It should be appreciated that the flowcharts and block diagrams in the FIGURES illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or alternative orders, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as suited to the particular use contemplated.

1. A method, comprising:
identifying a database object stored in a database, wherein the database object is associated with a computing application that is executable by one or more processors;
accessing a transaction history associated with the database object;
determining a criticality level associated with the database object based on the transaction history; and
configuring one or more database maintenance tasks associated with the database object based on the criticality level.

2. The method of claim 1, wherein the transaction history comprises a plurality of transaction metrics, wherein the plurality of transaction metrics comprises:
a hit ratio associated with the database object;
a copy frequency associated with the database object; or
a reorganization frequency associated with the database object.

3. The method of claim 1, wherein determining the criticality level associated with the database object based on the transaction history comprises:
accessing a plurality of transaction histories associated with a plurality of database objects, wherein the plurality of database objects comprises the database object;
partitioning the plurality of database objects into a plurality of clusters based on the plurality of transaction histories;
assigning a plurality of criticality levels to the plurality of clusters;
identifying a particular cluster of the plurality of clusters that comprises the database object; and
identifying the criticality level corresponding to the particular cluster.

4. The method of claim 3, wherein partitioning the plurality of database objects into the plurality of clusters based on the plurality of transaction histories comprises:
applying a machine learning clustering model based on the plurality of transaction histories; and
identifying the plurality of clusters based on an output of the machine learning clustering model.

5. The method of claim 1, wherein determining the criticality level associated with the database object based on the transaction history comprises:
computing a criticality index associated with the database object based on the transaction history; and
determining the criticality level based on the criticality index associated with the database object.

6. The method of claim 5, wherein determining the criticality level based on the criticality index associated with the database object comprises:
identifying a plurality of ranges corresponding to a plurality of criticality levels;
identifying a particular range of the plurality of ranges that the criticality index falls within; and
identifying the criticality level corresponding to the particular range, wherein the criticality level is identified from the plurality of criticality levels.

7. The method of claim 6, wherein identifying the plurality of ranges corresponding to the plurality of criticality levels comprises:
identifying a plurality of criticality indexes associated with a plurality of database objects;
identifying a statistical distribution of the plurality of criticality indexes; and
determining the plurality of ranges based on the statistical distribution.

8. The method of claim 6, wherein the plurality of criticality levels comprises a low criticality level, a medium criticality level, and a high criticality level.

9. The method of claim 1, further comprising:
determining that a new database object has been added to the database;
accessing a partial transaction history associated with the new database object;
accessing a plurality of transaction histories associated with a plurality of existing database objects stored in the database;
accessing criticality data associated with the plurality of existing database objects; and
determining a predicted criticality level of the new database object, wherein the predicted criticality level is determined based on:
the partial transaction history associated with the new database object;
the plurality of transaction histories associated with the plurality of existing database objects; and
the criticality data associated with the plurality of existing database objects.

10. The method of claim 9, wherein determining the predicted criticality level of the new database object comprises:
training a machine learning classification model, wherein the machine learning classification model is trained based on the plurality of transaction histories associated with the plurality of existing database objects and the criticality data associated with the plurality of existing database objects;
applying the machine learning classification model to the partial transaction history associated with the new database object; and
determining the predicted criticality level of the new database object based on an output of the machine learning classification model.

11. The method of claim 9, further comprising:
configuring one or more second database maintenance tasks associated with the new database object based on the predicted criticality level.

12. The method of claim 1, wherein the database object comprises:
a database table; or
a database index.

13. A non-transitory computer readable medium having program instructions stored therein, wherein the program instructions are executable by a computer system to perform operations comprising:
identifying a database object stored in a database, wherein the database object is associated with a computing application that is executable by one or more processors;
accessing a transaction history associated with the database object;
determining a criticality level associated with the database object based on the transaction history; and
configuring one or more database maintenance tasks associated with the database object based on the criticality level.

14. A system, comprising:
a processing device;
a memory; and
a database management engine stored in the memory, the database management engine executable by the processing device to:
identify a database object stored in a database, wherein the database object is associated with a computing application that is executable by processing device;
access a transaction history associated with the database object;
determine a criticality level associated with the database object based on the transaction history; and
configure one or more database maintenance tasks associated with the database object based on the criticality level.

15. The system of claim 14, wherein the transaction history comprises a plurality of transaction metrics, wherein the plurality of transaction metrics comprises:
a hit ratio associated with the database object;
a copy frequency associated with the database object; or
a reorganization frequency associated with the database object.

16. The system of claim 14, wherein the database management engine executable by the processing device to determine the criticality level associated with the database object based on the transaction history is further executable to:
access a plurality of transaction histories associated with a plurality of database objects, wherein the plurality of database objects comprises the database object;
partition the plurality of database objects into a plurality of clusters, wherein the plurality of database objects is partitioned based on a machine learning clustering model applied to the plurality of transaction histories;
assign a plurality of criticality levels to the plurality of clusters;
identify a particular cluster of the plurality of clusters that comprises the database object; and
identify the criticality level corresponding to the particular cluster.

17. The system of claim 14, wherein the database management engine executable by the processing device to determine the criticality level associated with the database object based on the transaction history is further executable to:
compute a criticality index associated with the database object based on the transaction history; and
determine the criticality level based on the criticality index associated with the database object.

18. The system of claim 17, wherein the database management engine executable by the processing device to determine the criticality level based on the criticality index associated with the database object is further executable to:
identify a plurality of criticality indexes associated with a plurality of database objects stored in the database;
identify a statistical distribution of the plurality of criticality indexes;
determine a plurality of ranges based on the statistical distribution, wherein the plurality of ranges corresponds to a plurality of criticality levels;
identify a particular range of the plurality of ranges that the criticality index falls within; and
identify the criticality level corresponding to the particular range.

19. The system of claim 14, wherein the database management engine is further executable by the processing device to:
determine that a new database object has been added to the database;
access a partial transaction history associated with the new database object;
access a plurality of transaction histories associated with a plurality of existing database objects stored in the database;
access criticality data associated with the plurality of existing database objects;
determine a predicted criticality level of the new database object, wherein the predicted criticality level is determined based on:
the partial transaction history associated with the new database object;
the plurality of transaction histories associated with the plurality of existing database objects; and
the criticality data associated with the plurality of existing database objects; and
configure one or more second database maintenance tasks associated with the new database object based on the predicted criticality level.

20. The system of claim 19, wherein the database management engine executable by the processing device to determine the predicted criticality level of the new database object is further executable to:
train a machine learning classification model, wherein the machine learning classification model is trained based on the plurality of transaction histories associated with the plurality of existing database objects and the criticality data associated with the plurality of existing database objects;
apply the machine learning classification model to the partial transaction history associated with the new database object; and
determine the predicted criticality level of the new database object based on an output of the machine learning classification model.
